(19) United States
(12) Patent Application Publication
(10) Pub. No.: US 2009/0216706 A1
(43) Pub. Date: Aug. 27, 2009

(54) MULTIPLE USER COMPUTER SYSTEM AND METHOD FOR MODIFYING DISPLAY PARAMETERS THEREOF

(75) Inventors: LUNG DAI, Tu-Cheng (TW); WANG-CHANG DUAN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(Shenzhen) CO., LTD., Shenzhen City (CN); HON HAI PRECISION INDUSTRY CO., LTD., Tu-Cheng (TW)

(21) Appl. No.: 12/274,337

(22) Filed: Nov. 19, 2008

(30) Foreign Application Priority Data
Feb. 22, 2008 (CN) 200810300382.4

(51) Int. Cl. G06F 17/00; G06F 17/30

(52) U.S. Cl. 706/54; 707/100; 707/E17.044

(57) ABSTRACT

An exemplary multiple user system is provided. The multiple user system includes a display module, a storage module, and a control module. The display module displays data and graphics according to default display parameters. The storage module stores different user accounts information and different display parameters associated with each user account. The control module identifies the currently logged in user to the multiple user computer system, and retrieves display parameters with the identified user account from the storage module. The control module compares the default display parameters with the retrieved display parameters, and adjusts the default display parameters to the retrieved display parameters upon the determination that the default display parameters and the retrieved display parameters do not match.

### BACKGROUND

1. Technical Field

The present disclosure relates to multiple user computer systems, and particularly to display parameters of a multiple user computer system.

2. Description of Related Art

Generally, display devices, such as computer monitors are provided with a plurality of push-buttons. The push-buttons can be actuated by a user to invoke modifiable user interfaces, also known as on screen displays (OSDs), for modifying display parameters such as brightness, contrast etc.

However, if there is more than one user, then each user must modify the settings manually each time if they have different preferences from the previous user.

Therefore, providing a multiple user computer system and a method for independently setting different display parameters for each user account are desired.

### BRIEF DESCRIPTION OF THE DRAWINGS

FIG. 1 is a schematic diagram of a multiple user computer system in accordance with an exemplary embodiment.

FIG. 2 is a detailed block diagram of the multiple user computer system of FIG. 1.

FIG. 3 is a flowchart illustrating a method of implementing the multiple user computer system of FIG. 1 to provide customized display parameters.

### DETAILED DESCRIPTION

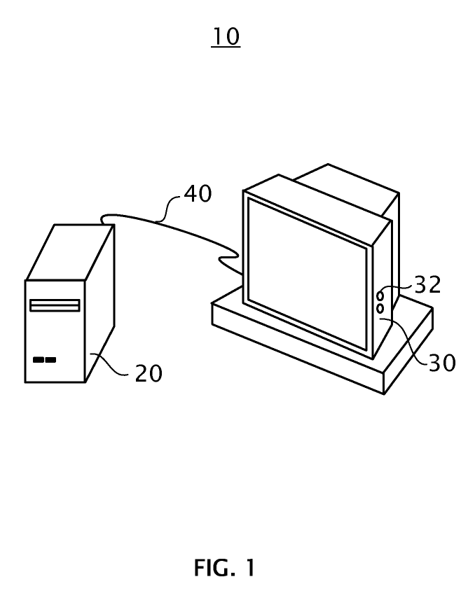

Referring to FIG. 1, a multiple user computer system 10 in accordance with an exemplary embodiment is illustrated. The multiple user computer system 10 includes a host machine 20 and a display device 30. The host machine 20 is coupled to the display device 30 by a communication connection 40. In the exemplary embodiment, the communication 40 is a cable. In other embodiments, the communication connection 40 may be wireless connection, such as WIFI and Bluetooth.

The display device 30 may be a computer monitor with default display parameters (e.g., brightness, contrast etc.). The default display parameters are capable of being modified by pressing buttons 32 disposed on the display device 30 and also by adjusting relevant software stored in the host machine 20, which will be described in detail hereafter.

The host machine 20 is capable of creating a number of user accounts, each account may include a user name, a password, a password hint, and one or more user preferences (e.g., brightness setting, contrast setting etc.). For each user account, the host machine 20 provides a separate environment such that the preferences are not accessible from other user accounts.

When the user logs in to the host machine 20 for the first time, the host machine 20 prompts the user to personalize their display parameters. For successive log-ins thereafter, the host machine 20 retrieves the personalized display parameters as set by the user, and the display device 30 displays the user's preferences accordingly. A user may modify their previous preferences any time they are logged in to their account.

When the host machine 20 is started, a user logs into his/her account on the host machine 20. The user can get access to resources stored locally on the host machine 20 or on a network to which the host machine 20 may be connected to after logging in. Thereafter, the user can modify and optimize the display parameters associated with the user account if they wish. Any modifications made to current display parameters are then associated with that user account and will be used in future sessions.

Table 1 (below) lists display parameters associated with each user account. For a first user account, herein named Lisa, the preferences include a high brightness setting and relatively average contrast setting. For a second user account, named Jim, the preferences include a low brightness setting and a high contrast setting. The display parameters associated with the first and second user accounts can be modified by the users according to their preferred display preferences. Thereafter, the display parameters associated with each user account are stored in the host machine 20 or stored in the display device 30. As listed in table 1, the user accounts may include other preferences, such as color and position preferences.

TABLE 1
user account and associated display parameters

| | Parameter | | | | | | |
|---|---|---|---|---|---|---|---|
| | Bright- | Contrast | | | | Horizontal | Vertical |
| Account | ness | Ratio | Red | Blue | Green | Position | Position |
| First | 70 | 35 | 50 | 50 | 50 | 50 | 40 |
| user | | | | | | | |
| account | | | | | | | |
| (Lisa) | | | | | | | |
| Second | 45 | 80 | 30 | 60 | 60 | 55 | 55 |
| user | | | | | | | |
| account | | | | | | | |
| (Jim) | | | | | | | |

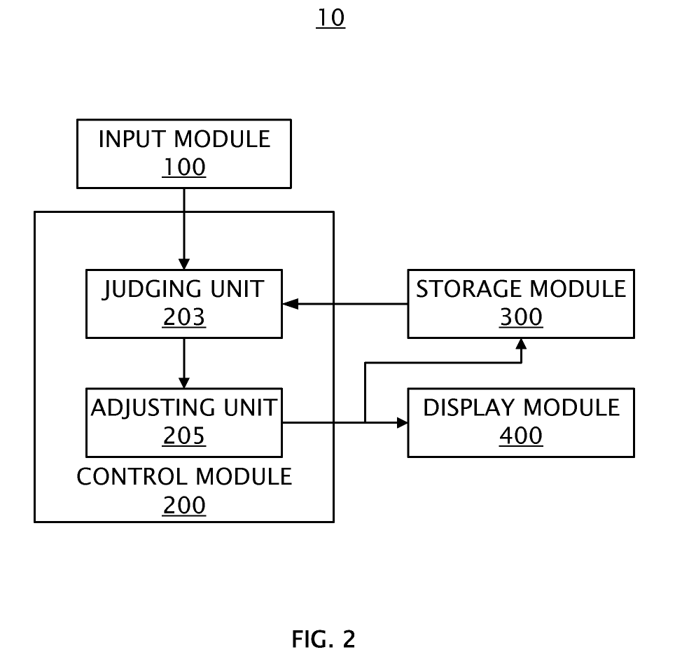

Referring to FIG. 2, a detailed block diagram of the multiple user computer system 10 in accordance with the exemplary embodiment will be described.

The multiple user computer system 10 includes an input module 100, a control module 200, a storage module 300, and a display module 400.

The input module 100 is configured for receiving various instructions/commands for creating user accounts information and adjusting display parameters etc. The input module 100 may be the buttons 32 provided in the display device 30 or a keyboard (not shown) coupled to the host machine 20, or software push buttons, or other suitable input device.

The control module 200 includes a judging unit 203 and an adjusting unit 205. The judging unit 203 is configured for receiving input from the input module 100. More specifically, the judging unit 203 extracts user account information of a user account. The judging unit 203 accesses the storage module 300 and retrieves the display parameters associated with the user account. The judging unit 203 compares the retrieved display parameters with the default display parameters to determine whether the default display parameters should be changed or not. When the retrieved display parameters do not match the default display parameters, the judging unit 203 transmits a modify signal. When the retrieved display parameters match the default display parameters, the judging unit 203 transmits a default signal.

The adjusting unit 205 is coupled to the judging unit 203 for receiving signals transmitted from the judging unit 203. The adjusting unit 205 controls the display module 400 to display data and graphics according to the default display parameters in response to the default signal. The adjusting unit 205 controls the display module 400 to display data and graphics according to the retrieved display parameters associated with the user account in response to the modify signal.

As mentioned above, the display module 400 automatically displays data and graphics according to personalized display parameters associated with each user account that is logged into the multiple user computer system 10. The personalized display parameters are modifiable according to user preferences, and the modified display parameters are stored in the display device or the host machine. Therefore, it is not needed to manually adjust the display parameters each time a different user uses the multiple user computer system 10, thus, the multiple user computer system 10 is much more user-friendly.

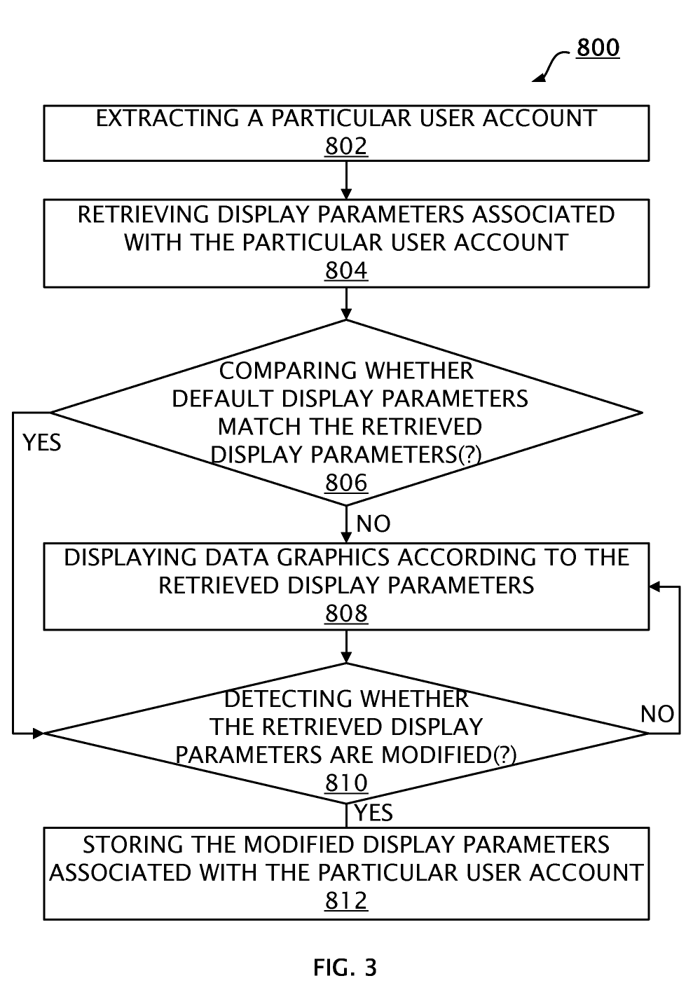

Referring to FIG. 3, a method 800, of modifying display parameters of the display device 30 of the multiple user computer system 10, is illustrated. The method 800 includes the following steps.

At step 802, a user logs in using the input module 100, and the judging unit 203 receives the input from the input module 100.

At step 804, the judging unit 203 retrieves display parameters associated with the user account. For first time use, the display parameters are preset and associated with the user account.

At step 806, the judging unit 203 determines whether the retrieved display parameters match the default display parameters. If yes, the procedure goes to step 810. If no, the procedure goes to step 808.

At step 808, the adjusting unit 205 controls the display module 400 to display data and graphics according to the retrieved display parameters associated with the user account.

At step 810, the inputting module 100 determines whether modification signals are inputted.

When the retrieved display parameters are not modified, the procedure loops back to the step 808, and the data and graphics are displayed according to the retrieved display parameters.

At step 812, the display parameters are modified and associated with the user account correspondingly. The modified display parameters are stored in the host machine 20 or stored in the display device 20.

As the method 800 described above, data and graphics are displayed according to preset display parameters associated with a user account. It is not needed to manually modify the display parameters each time a user log in to his account in a multiple user computer system 10, thus, time is saved when operating in a multiple user computer system 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A multiple user computer system allowing a number of users utilizing the multiple user computer system, the multiple user computer system comprising:
a display module for displaying data and graphics according to default display parameters;
a storage module for storing different user accounts and different display parameters associated with the user accounts; and
a control module for identifying a user account in the multiple user computer system, and retrieving display parameters associated with the user account from the storage module;
wherein the control module compares the default display parameters with the retrieved display parameters, and adjusts the default display parameters to the retrieved display parameters upon determination that the default display parameters and the retrieved display parameters do not match, thereby the display device display the data and graphics according to the retrieved display parameters.

2. The multiple user computer system according to claim 1, further comprising:
an input module for inputting user account information allowing the user to login to the multiple user computer system.

3. The multiple user computer system according to claim 2, wherein the control module comprises:
a judging unit for extracting information of the user account from the multiple user computer system, the judging unit accesses the storage unit to retrieve display parameters associated with the user account, and compares the retrieved display parameters with the default display parameters to determine whether the default display parameters should be modified.

4. The multiple user computer system according to claim 3, wherein the control module further comprises:
an adjusting unit configured for controlling the display module to display the data and graphics according to the retrieved display parameters if the retrieved display parameters do not match the default display parameters.

5. The multiple user computer system according to claim 4, wherein the adjusting module modifies the retrieved display parameters according to a logged in user's input, and stores the modified display parameters associating with the user account.

6. A multiple user computer system allowing a number of users utilizing the multiple user computer system, the multiple user computer system comprising:
a host machine created with a first user account associated with first display parameters and a second user account associated with second display parameters different from the first display parameters; and
a display device coupled to the host machine by a communication connection for displaying data and graphics;
wherein the display device displays the data and graphics according to the first display parameters associating with the first user account when the first user account is logged in to the host machine, and displays the data and graphics according to the second display parameters associating with the second user account when the second user is logged in to the host machine.

7. The multiple user computer system according to claim 6, wherein the display device displays the data and graphics according to default display parameters when the first display parameters associated with the first user account is determined to match with the default display parameters.

8. The multiple user computer system according to claim 6, wherein the first display parameters and the second display parameters associated with the first user account and the second user account respectively are stored in the display device.

9. The multiple user computer system according to claim 6, wherein the first display parameters and the second display parameters associated with the first user account and the second user account respectively are stored in the host machine.

10. The multiple user computer system according to claim 6, wherein the first display parameters are modified to be associated with the first user account when the first user is utilizing the display device.

11. The multiple user computer system according to claim 6, wherein the second display parameters are modified to be associated with the second user account when the second user is utilizing the display device.

12. The multiple user computer system according to claim 6, wherein the communication connection is a cable.

13. The multiple user computer system according to claim 6, wherein the communication connection is wireless.

14. A method for modifying display parameters of a display device that is utilized by a multiple user computer system, the method comprising:
indentifying an account associated with a logged in user to the multiple user computer system;
retrieving display parameters associated with the logged in user account from a storage module of the multiple user computer system;
comparing whether the retrieved display parameters match default display parameters; and
displaying data and graphics according to the retrieved display parameters upon determination that the retrieved display parameters do not match the default display parameters.

15. The method according to claim 14, further comprising:
displaying data and graphics according to the default display parameters upon determination that the retrieved display parameters match the default display parameters.

16. The method according to claim 14, further comprising:
detecting whether the retrieved display parameters are modified; and
storing the modified display parameters associated with the user account if the retrieved display parameters are modified.

17. The method according to claim 16, further comprising:
storing the modified display parameters in a host machine of the multiple user computer system.

18. The method according to claim 16, further comprising:
storing the modified display parameters in a display device of the multiple user computer system by transmitting the modified display parameters by a communication connection.

19. The method according to claim 18, wherein the communication connection is a cable.

20. The method according to claim 18, wherein the communication connection is wireless.
